(19) United States
(12) Patent Application Publication
(10) Pub. No.: US 2009/0093297 A1
(43) Pub. Date: Apr. 9, 2009

(54) GAMING DEVICE AND METHOD INCLUDING SECONDARY WAGER

(76) Inventors: Jerald C. Seelig, Galloway, NJ (US); Lawrence M. Henshaw, Hammonton, NJ (US)

Correspondence Address: IAN F. BURNS & ASSOCIATES, 4790 Caughlin Parkway #701, RENO, NV, 89519-0907, US

(21) Appl. No.: 12/243,656

(22) Filed: Oct. 1, 2008

Related U.S. Application Data
(60) Provisional application No. 60/977,339, filed on Oct. 3, 2007.

(51) Int. Cl. A63F 9/24; A63F 13/00

(52) U.S. Cl. 463/20

(57) ABSTRACT

A method of playing a gaming device comprises receiving a primary wager and a secondary wager. A single gaming event is used to determine the outcome of the primary wager. The outcome of the secondary wager is determined from a plurality of single gaming events.

### CROSS REFERENCE TO RELATED APPLICATIONS

This application claims priority to U.S. provisional patent application Ser. No. 60/977,339, filed Oct. 3, 2007, the contents of which is herein incorporated by reference.

### FIELD OF THE INVENTION

The present invention relates to gaming devices and methods of playing gaming devices. More particularly, the invention relates to gaming devices and methods incorporating secondary wagers.

### BACKGROUND

Gaming devices, such as slot machines, are common in gaming establishments. The mechanism of playing a slot machine is well known. In general, a player places a wager in respect of a single gaming event. In modern slot machines, the single gaming event is typically the generation of a random number that is compared against a pay table to determine if the single gaming event produced a winning outcome. A winning outcome may be a multiple of the wager with the multiple being dependent on the probability of that winning outcome.

Multiple games can be played simultaneously within a single gaming event by advancing multiple wagers. However, the mechanism of determining the winning outcome is largely unchanged. That is, if multiple wagers are placed, an equal multiple of random numbers are generated and compared against the pay table. The playing of multiple lines adds excitement to the game player by increasing the chances of winning on a single gaming event, however at the cost of the multiple wagers.

In some instances, a winning outcome may trigger the playing of a bonus game which can increase the multiple that the player can win, thereby increasing the excitement to the player.

While the variation of bonus games can provide some sense of difference between different gaming machines, the format of slot-type gaming machines is well established. There is, therefore little reason for a player to choose to play one gaming machine over another.

### SUMMARY OF ONE EMBODIMENT OF THE INVENTION

### Advantages of One or More Embodiments of the Present Invention

The various embodiments of the present invention may, but do not necessarily, achieve one or more of the following advantages:

an increased incentive for players to utilize a gaming device;

provide a greater number of possible winning outcomes;

provide a prolonged playing experience through the playing of an aggregate game;

provide greater interactivity between players;

provide an increased incentive for a player to continue playing at a slot machine;

provide an opportunity for a player to win on a losing outcome of a gaming device;

provide an increased number of repeat players; and

provide an additional source of revenue for the gaming establishment.

These and other advantages may be realized by reference to the remaining portions of the specification, claims, and abstract.

### Brief Description of One Embodiment of the Present Invention

In one aspect, the invention relates to a method of playing a gaming device. A primary wager and a secondary wager are received and a primary outcome and a secondary outcome are determined. The primary outcome is dependent on a single gaming event and the secondary outcome is dependent on a plurality of the single gaming events.

In one aspect, the invention relates to a gaming device comprising means for receiving a primary wager and means for receiving a secondary wager. Means for determining a primary outcome and means for determining a secondary outcome are provided, wherein the primary outcome is determined from a single gaming event and wherein the secondary outcome is determined from a plurality of the single gaming events.

In one aspect, the invention relates to a gaming network comprising a plurality of gaming devices, each configured to allow a player to place a primary wager and play a primary game, and a server in communication with the plurality of gaming machines and configured to determine an outcome of the primary game. At least one gaming machine is configured to allow a player to place a secondary wager and to play a secondary game wherein the server determines a secondary game outcome from a plurality of single gaming events.

In one aspect, the invention relates to a gaming device comprising a housing, a wager acceptor mounted in the housing, a display mounted in the housing and a controller in communication with the wager acceptor and the display. The wager acceptor is adapted to accept a wager from a game player. The display is configured to communicate a game outcome. The controller is configured to determine a primary outcome from a single gaming event and determine a secondary outcome from a plurality of the single gaming events.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic view depicting a gaming machine suitable for use in an embodiment of the invention;

FIG. 2 is a flow diagram of a method of playing the gaming machine of FIG. 1;

FIG. 3 is a flow diagram depicting a method of playing a secondary game on the gaming machine of FIG. 1; and

FIG. 4 is substantially a schematic view of a network of gaming machines.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

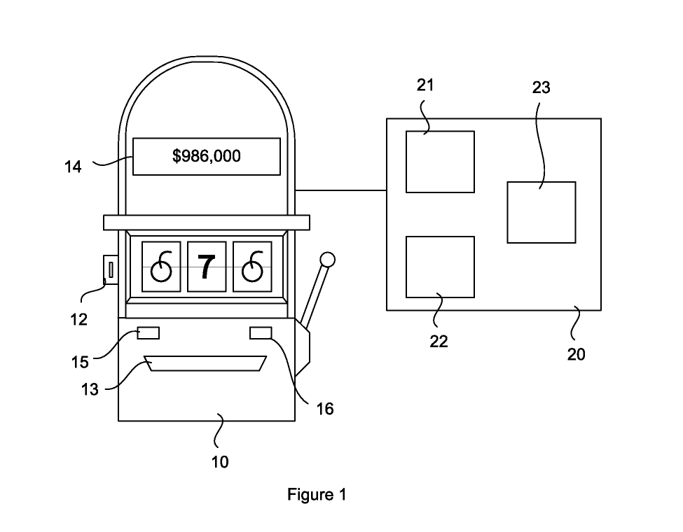

In FIG. 1, there is shown a slot machine 10. The slot machine 10 includes a coin slot 12 for receiving wagers such as coins or tokens and a payout slot 13 through which winnings may be paid. The slot machine may incorporate a progressive game 14. The person skilled in the art will readily understand that the slot machine is depicted schematically and many variants may be made. For example, the slot machine 10 may be configured to receive bills, casino tokens, credit cards or many other forms of payment. Similarly, winnings may be paid by tokens, tickets, credit or through other facilities of the gaming establishment. The slot machine may have a video display configured to show video reels, as is known.

The slot machine 10 is operatively associated with a computer system 20. The computer system includes a processor 21, memory 22 and random number generator 23. While the random number generator 23 is shown as a distinct component, the person skilled in the art will readily understand that the random number generator may be embodied within the processor 21. The computer system may be provided within the slot machine 10 or may be provided elsewhere in the gaming establishment and communicate with the slot machine 10 through a server, as is known.

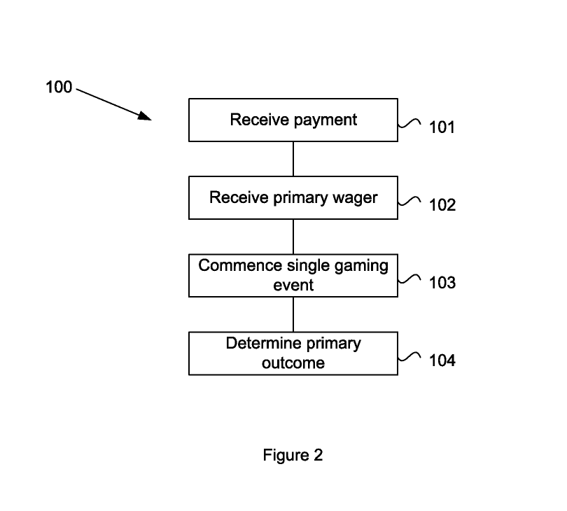

A method of playing the slot machine will now be described with reference to FIG. 1 and the flow diagram 100 of FIG. 2. At step 101, a player commences play by inserting some form of payment into the slot machine, for example through coin slot 12. The payment may take the form of coins, tokens, bills, or any suitable form. Using control button 15 on the slot machine 10, the player then elects a primary wager. For example, the player may elect a number of lines of the slot machine to be played, and an amount to be wagered per line (step 102). Having elected a wager, the player then selects a “PLAY” button 16, or similar to commence a single gaming event of the primary game (step 103). Random numbers are then generated by random number generator 23 and compared to a pay table, which may be stored in memory 22, to determine whether a winning outcome has occurred (step 104). If a winning outcome has occurred, a bonus game may be triggered, at the conclusion of which, or if no bonus game is played, any winnings are credited to the player. The placing of the wager and determination of the winning outcome represents a single gaming event and is generally known within the art.

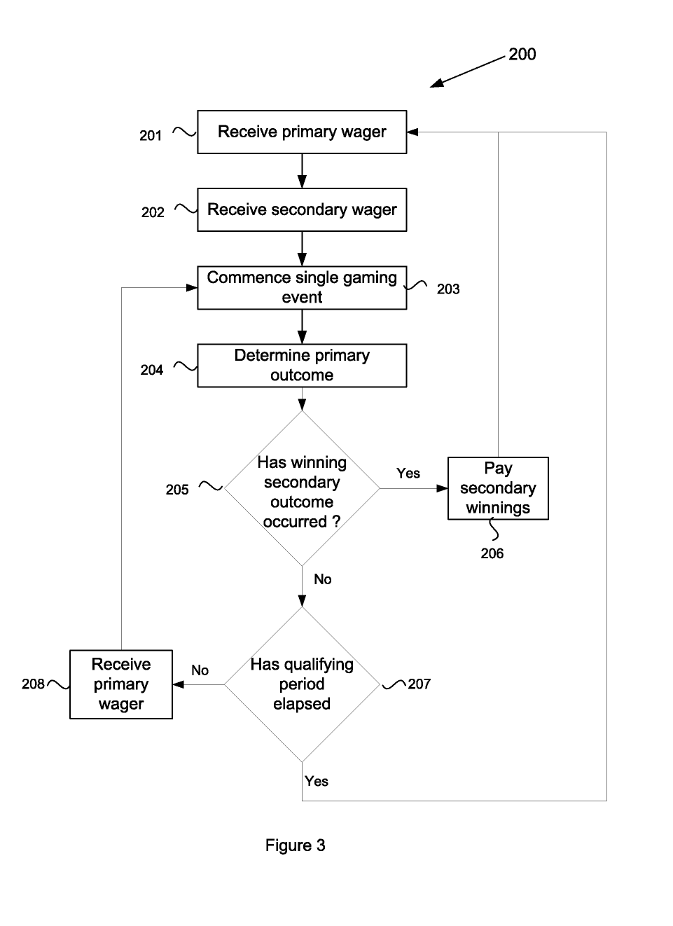

A method of playing the game in accordance with an embodiment of the invention will now be described with reference to the flow diagram 200 of FIG. 3. At step 201, the player places a primary wager in a gaming machine as usual. After the wager is placed the machine prompts the player to place an additional or secondary wager (step 202). The secondary wager may be with respect to whether a secondary outcome is satisfied. The secondary outcome may be dependent on a qualifying period. For example, a winning outcome on the secondary wager may require a secondary outcome to occur within a period of time or a predetermined number of single gaming events of the slot machine. Examples of a secondary outcome will be described in detail below. A single gaming event is then played (step 203) and the outcome of the primary wager is determined (step 204). If a winning secondary outcome has occurred, as determined at step 205, then winnings are paid on the secondary outcome 206 and play returns to the beginning. If no winning secondary outcome has occurred, then a determination is made as to whether a qualifying period for the secondary outcome has expired 207. If the qualifying period is still current, then further primary wagers may be taken 208 and the playing of the single gaming event is repeated 203. If the qualifying period has expired, then a further wager is required for both the primary and wages and thus the play returns to the beginning. As described above and in greater detail below, in various embodiments the qualifying period may comprise a predetermined number of single gaming events or a predetermined time period. Other forms of qualifying period based on a plurality of the single gaming events are also possible.

In one embodiment, the secondary outcome may occur within an aggregate of single gaming events. For example, a winning outcome for the secondary wager may occur if the player receives an aggregate of five cherry symbols over the next five plays. That is, in order to win on the secondary outcome, the player may receive one cherry symbol per play, i.e., per single gaming event. Alternatively, the player may receive zero cherry symbols on each of two plays, one cherry symbol on each of two plays, and three cherry symbols on one play. Incidentally, receiving three cherry symbols on one play may satisfy a winning outcome on the primary wager.

If the player satisfies a winning secondary outcome, for example, as described above, the player is awarded a secondary payout in addition to any winnings earned on the primary wagers of the individual gaming events. The secondary payout may be a fixed amount or may equal a multiple of the secondary wager. A secondary award table that is directly linked to the additional types of wagers that the player can make may be displayed on the gaming machine much like the pay table for the primary awards and bonus awards.

In one embodiment, instead of the secondary outcome being dependent on a predetermined number of single gaming events, the secondary outcome may be dependent on the number of single gaming events played within a predetermined period of time. For example, a winning outcome for the secondary wager may occur if the player receives five cherry symbols within the next one minute of play. This embodiment has the advantage of increasing the sense of urgency in the player and therefore the player's excitement level as well as the advantage for the gaming establishment in encouraging rapid play.

In one embodiment, a secondary wager may be placed on how many credits the player will win in a predetermined number of plays, e.g. five plays, or within a predetermined period of time, such as within the next five minutes.

In one embodiment, a player may place a secondary a wager on whether they will lose all of their credits within a number of gaming events, e.g., five plays, or within a period of time, e.g., five minutes. In the case that the player did lose, the player would be awarded additional credits based on having won the secondary wager. This embodiment has advantage because it creates more excitement in the game as players run out of credits by providing an incentive to make the secondary wager.

In one embodiment, a player may wager that they will not achieve a predetermined winning outcome(s) on a single gaming event, i.e., on the primary wager, within a number of plays or within a period of time. In one embodiment, the predetermined winning outcome may be any winning outcome on a single gaming event, so that if the player was unsuccessful on the primary wager, the player would win the secondary wager. This embodiment has advantage by providing insurance to the player against a losing outcome on the primary game. In particular, the player can insure against a long losing streak.

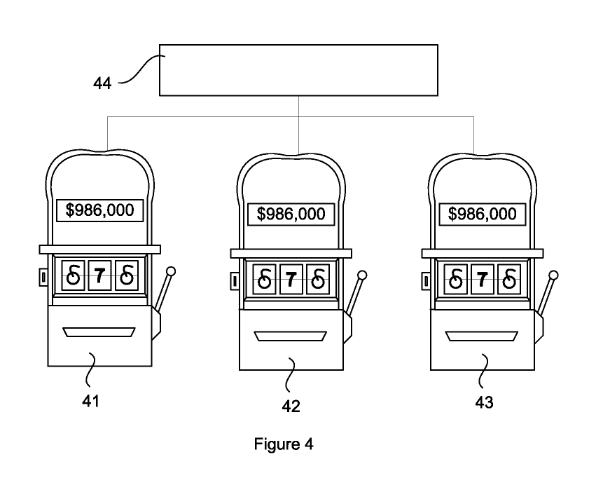

In one embodiment illustrated in FIG. 4, a network of gaming machines 41, 42, 43 can be operated under the control of a server 44, as is known, and each gaming machine can be provided with the capacity to place a secondary wager. The outcome of the secondary wager may be dependent on the single game events of one or more of the gaming machines in the network. For example, if five machines are in operation, a secondary wager may be placed on whether an aggregate of five cherries will be produced across the five gaming machines on the next single gaming event of each of the machines.

Increased player interactivity can be encouraged by allowing players to wager against each other on a particular outcome. For example, the players on a network of games may place a secondary wager that they will or will not achieve a certain outcome before the other players and they could also wager on various outcomes occurring on another player's machine. In one example, a player may place a secondary wager that they will win a pre-determined number of credits before the other player. The first player to win that number of credits wins the secondary wager, or a multiple thereof, from the other player. This embodiment has advantage by encouraging players to wager more on the primary outcomes in the hope of attaining the required number of credits and therefore winning the secondary wager.

In one embodiment, players at different gaming machines can collectively place a secondary wager on an outcome being produced within a period, allowing the players to share in an award if the outcome was produced.

In one embodiment, it is not necessary for one secondary outcome to be completed before the next secondary wager is taken. Instead, there may be overlap in the placing of secondary wagers. Using the aggregate example described above, a secondary wager may be placed, the outcome of which is dependent on an aggregate of the next five plays. It is not necessary for the five plays to be completed prior to taking the next secondary wager. An additional secondary wager may be taken within any of the next five plays, say, on the fourth play, with the additional secondary wager being dependent on an aggregate of the fourth to eighth plays. This provides the player with additional excitement because, if, for example three cherries were to appear on the fourth play, the player has a high chance of winning both secondary wagers.

In one embodiment, the slot machine is preprogrammed with one or more available secondary winning outcomes. The player may be able to select one or more of the available winning outcomes to wager against. Alternatively, the program controlling the game machine may select one or more secondary outcomes to offer to the player to wager against. Where multiple secondary outcomes are utilized, each secondary outcome may be wagered against individually, or the secondary outcomes may be wagered against collectively by placing a single secondary wager.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A method of playing a gaming device comprising:
(A) receiving a primary wager;
(B) receiving a secondary wager;
(C) determining a primary outcome, wherein the primary outcome is dependent on a single gaming event; and
(D) determining a secondary outcome, wherein the secondary outcome is dependent on a plurality of the single gaming events.

2. The method according to claim 1 wherein determining the secondary outcome comprises determining the outcome of a predetermined number of single gaming events.

3. The method according to claim 1 wherein determining the secondary outcome comprises determining the outcome of a plurality of single gaming events played within a predetermined period of time.

4. The method according to claim 1 wherein the secondary outcome is a winning outcome if a predetermined outcome occurs in at least one of the plurality of single gaming events.

5. The method according to claim 1 wherein the secondary outcome is a winning outcome if a predetermined outcome occurs within an aggregate of the plurality of the single gaming events.

6. The method according to claim 5 wherein the predetermined outcome comprises a predetermined number of a gaming symbol.

7. The method according to claim 5 wherein the predetermined outcome comprises winning a predetermined number of credits in the plurality of single gaming events.

8. The method according to claim 5 wherein the predetermined outcome comprises a plurality of losing primary outcomes in the plurality of single gaming events.

9. The method according to claim 1 wherein determining a secondary outcome comprises determining the outcome of a plurality of single gaming events on a plurality of gaming machines.

10. The method according to claim 1 wherein the secondary outcome is dependent on at least one losing outcome of the plurality of single gaming events.

11. A gaming device comprising:
(A) means for receiving a primary wager;
(B) means for receiving a secondary wager;
(C) means for determining a primary outcome, wherein the primary outcome is determined from a single gaming event; and
(D) means for determining a secondary outcome, wherein the secondary outcome is determined from a plurality of the single gaming events.

12. The gaming device according to claim 11 wherein the means for determining a secondary outcome comprises means for determining an aggregate outcome of the plurality of single gaming events.

13. The gaming device according to claim 12 comprising means for determining an aggregate outcome of a predetermined number of single gaming events.

14. The gaming device according to claim 12 comprising means for determining an aggregate outcome of a plurality of single gaming events that are played within a predetermined time after receiving the secondary wager.

15. The gaming device according to claim 11 comprising means for displaying an offer of the secondary wager to a player.

16. A gaming system comprising:
(A) a plurality of gaming machines each configured to allow a player to place a primary wager and play a primary game;
(B) a server in communication with the plurality of gaming machines and configured to determine an outcome of the primary game;
(C) wherein at least one gaming machine is configured to allow a player to place a secondary wager and to play a secondary game;
(D) wherein the server determines a secondary game outcome; and
(E) wherein the server determines the secondary outcome from a plurality of single gaming events.

17. The gaming network according to claim 16 wherein the server determines the secondary outcome from a plurality of single gaming events on a single gaming machine.

18. The gaming network according to claim 16 wherein the server determines the secondary outcome from a plurality of single gaming events on a plurality of gaming machines.

19. The gaming network according to claim 18 wherein a winning secondary outcome comprises an aggregate number of a gaming symbol on a plurality of single gaming events on a plurality of gaming machines.

20. The gaming network according to claim 18 wherein a winning secondary outcome comprises achieving a predetermined number of a gaming symbol on a first gaming machine prior to achieving a predetermined number of the gaming symbol on a second gaming machine.

21. A gaming device comprising:
(A) a housing;
(B) a wager acceptor mounted in the housing, the wager acceptor adapted to accept a wager from a game player;
(C) a display mounted in the housing, the display being configured to communicate a game outcome; and
(D) a controller in communication with the wager acceptor and the display, the controller configured to:
(a) determine a primary outcome from a single gaming event; and
(b) determine a secondary outcome from a plurality of the single gaming events.

22. The gaming device of claim 21 wherein the controller is configured to determine an aggregate outcome of the plurality of single gaming events.

23. The gaming device according to claim 21 wherein the controller is configured to determine an aggregate outcome of a predetermined number of single gaming events.

24. The gaming machine according to claim 21 wherein the controller is configured to determine an aggregate device of a plurality of single gaming events that are played within a predetermined time after receiving the secondary wager.

25. The gaming device according to claim 21 wherein the display is configured to display an offer of a secondary wager to a player in respect of the secondary outcome.
